(19) United States
(12) Patent Application Publication
(10) Pub. No.: US 2006/0278107 A1
(43) Pub. Date: Dec. 14, 2006

(54) Method, device and container for dosing ink

(76) Inventor: Mireia Hernandez Estaban, Barcelona (ES)

Correspondence Address: LEONARD R. NITZBERG;1413 BUCKEYE LANE, KNOXVILLE, TN, 37919, US

(21) Appl. No.: 10/553,646

(22) PCT Filed: Apr. 16, 2004
(86) PCT No.: PCT/ES04/00168

§ 371 Date: Dec. 19, 2005

(30) Foreign Application Priority Data
Apr. 16, 2003 (EP) P200300953

(51) Int. Cl. B41K 1/38

(52) U.S. Cl. 101/335

(57) ABSTRACT

The method involves providing ink in a container having deformable walls; placing the container in a dosing system comprising a deposit into which a dosage of ink is poured; providing ink in a container with deformable walls that is fitted with means for opening the container, supporting the filled or partially filled container in the dosing system; opening the container with the aid of the opening means thereby defining a hole and exerting pressure against the walls of said container and against said hole with the aid of pressing or flattening means. Due to the deforming properties of the walls of the container and as a result of the flattening of the walls, the combined pressing action pushes the ink contained in the container against the hole through which a dosage of ink is poured out.

### TECHNICAL FIELD OF THE INVENTION

The present invention relates to a process and a device for dispensing inks, as well to an ink container to use in conjunction with the process and the device.

The process of the invention is of the type that comprise supplying ink in a container and arranging the container in a dispensing system, which comprises a tank wherein doses of ink are poured, while the device is of the type which comprise support means for the ink container, ink dispensing means and a tank wherein doses of ink are poured from the ink container.

The present invention is equally applicable to inks, paints and basic dyes for producing paints.

### BACKGROUND OF THE INVENTION

The supply of ink, in particular in printing machines and in ink blocks and systems to produce paint mixtures from primary bases, is performed conventionally from a tank for the dye or paint, from where, by pumping or gravity, the paint or the dye is carried to the dispenser to be dispensed, to the ink block in some cases, or a mixture of both in others.

Currently, inks or paint mainly come packaged in tin-type containers, from where they are carried, conventionally manually using spatulas, to said receptacles. Likewise, the mixture of primary bases to produce paints is mainly performed manually, providing previously estimated doses of each dye from the tins in a receptacle.

The almost universal use of tins as containers for these inks or primary bases, involves a first type of problems, derived from the use of these conventional containers. On the one handy, once used, for reasons of environmental requirements, these conventional tin-type containers should obligatorily be recycled or eliminated, which, due to the high weight/volume ratio of the empty tins, considerably increases the cost of transport to the recycling plant or to the dump, consequently increasing the final cost of the printing or the manufactured paint. On the other hand, handling the tins supposes an important bottleneck in the entire production process, and makes it more labour intensive, which also redounds negatively in the final cost for the user.

Another type of problem is inherent to the product dispensing. There thus exists a good number of embodiments of automatic or semi-automatic dispensing systems of ink or paint from the receptacle, from where it is dispensed to a lower receptacle provided with a load cell which, once it captures a predetermined weight of dye, orders the closure of the upper tank valve to stop the pouring. In the case of paint manufacturing, this operation is repeated for each one of the primary bases until the mixture is formed with the desired proportions from each one of them.

Although these current automatic or semi-automatic systems have correct functionality, they are not completely free from problems and drawbacks, among which we can highlight the notorious complexity and high price and the fact that final dripping occurs when the valve is closed which may lessen the accuracy of the dispensing, dirtying the fittings, in particular the tank, wherein dry residues may remain, and hindering the subsequent operation.

In the case of UV dyes, as these contain additional photoinitiation additives, when pumps are involved, the additional problem arises that the friction produced in the pump may damage the dye.

The present invention has the purpose of providing the simultaneous solution to all the previous problems stated in the art.

### EXPLANATION OF THE INVENTION

For said purpose, according to a first aspect of the present invention, the object of the present invention is a process for dispensing inks of the type indicated at the start, of novel concept and functionality, which is essentially characterized in that it comprises the steps of:
supplying the ink in a container with deformable walls, provided with container opening means;
supporting the full or partially full container in the dispensing system;
opening the container using the opening means, determining an opening; and
exerting pressure, using pressure and flattening means, against the container walls, against said outlet,
   so that the combined action of compression pushes the ink contained in the container, thanks to the possibility of deforming the container walls, by the flattening thereof, against the opening, whereby a dose of ink exits.

According to another characteristic of the process of the invention, the step of exerting pressure is performed for a predetermined time, said doses of ink being in accordance with said predetermined time.

The process may comprise a dispensing time control step, wherein said predetermined time is controlled by control means.

Said control step preferably comprises measuring the weight of the dose which exits the outlet.

The time control step may also comprise measuring the height, in the tank, of the dispensed fluid of the dose that exits the outlet.

According to another characteristic of the process of the invention, the outlet is fixed, in the dispensing system, in a lower position, and said pressure is exerted downwards against the deformable walls of the container.

In a first preferred variant, the step of exerting pressure comprises exerting pressure using a plunger.

In a second preferred variant, the step of exerting pressure comprises exerting pressure by the action of at least two antagonistic cylinders which are vertically placed downwards against the container walls.

In a third preferred variant, the step of exerting pressure comprises exerting pressure using at least one cylinder which is simultaneously vertically displaced downwards against the deformable walls of the container and against a fixed, non-deformable wall of the dispensing system.

In a fourth preferred variant, the step of exerting pressure comprises simultaneously exerting pressure against the deformable walls of the container and against a fixed, non-deformable wall of the dispensing system, by a handle of a connecting rod-handle mechanism actuated by a manual plunger or lever.

In accordance with a second aspect of the present invention, a container is disclosed to dispense inks, to be used in a disclosed process, characterized in that its walls are deformable.

According to the invention, the container may comprise an outlet to dispense the contained ink.

The container of the invention may further comprise outlet-opening means.

In a first variant of the opening means, they comprise a stopper.

In a second variant of the opening means, they comprise a device of the type known as “push-pull”, wherein when an element surrounding the outlet is pulled, it opens, closing when said element is pressed.

It has also has been provided that the container according to the present invention may comprise coupling means of the outlet to the fixed part of the dispensing system.

In another variant of the opening means, they comprise a lower valve, whose valve body comprises an inner space which connects to the inside of the container, the sealing element of the valve being a cap, displaceable between a position of maximum opening and a closed position, wherein the larger base of the seal is essentially level with the valve outlet, closing the container.

In said case, the sealing element is preferably joined to an actuating rod which runs through the inside of said inner cylindrical space of the valve body and which is actuated by a tappet, against the action of a spring.

In a third aspect of the present invention, a device is disclosed for dispensing inks, for the implementation of an aforementioned process and to be used in conjunction with an aforementioned container, and which is essentially characterized in that it comprises container outlet opening means, and in that the ink dispensing means comprise means for exerting pressure against the deformable walls of the container, against said container outlet, so that the combined action of compression pushes the ink contained in the container, thanks to the possibility of deforming the deformable walls of the container, by the flattening thereof, against the opening, whereby a dose of ink exits towards said tank.

According to another characteristic, the device comprises operating time control means for the pressure and flattening means on the container.

Preferably, the control means comprise means to measure the weight of the dose of ink that exits the container outlet.

Also preferably, the control means comprise height measuring means, in the tank, of the fluid dispensed of the dose that exits the outlet.

In a preferred embodiment, the opening means are arranged in a lower position, and the pressure and flattening means are adapted for exerting pressure downwards against the deformable walls of the container.

In a first variant of the pressure and flattening means, they comprise a plunger that acts on deforming the container against the opening.

In a second variant of the pressure and flattening means, they comprise at least two antagonistic cylinders which are displaced vertically and in parallel to one another against the deformable walls of the container and against the opening.

In a third variant of the pressure and flattening means, they comprise at least one cylinder which is simultaneously vertically displaced downwards against the deformable walls of the container, against a fixed, non-deformable wall of the dispensing system and against the opening.

In a fourth variant of the pressure and flattening means, they comprise a handle of a connecting rod-handle mechanism actuated by a plunger, adapted to simultaneously exert pressure against the deformable walls of the container, against a fixed, non-deformable wall of the dispensing system and against the opening.

In a fifth variant of the pressure and flattening means, they comprise a plate, actuated by at least one cylinder, which exerts pressure simultaneously and perpendicularly against the deformable walls of the container and against a fixed, non-deformable wall of the dispensing system.

People skilled in the art will appreciate that the process, device and container of the present invention integrate a single general inventive concept, whose new and inventive characteristics permit resolving the aforementioned drawbacks. Furthermore, the scope of application of the present invention is not limited to its use in paints and dyes, but it can be extended to products of similar rheology to that of dyes and paints which have similar dispensing problems.

### BRIEF DESCRIPTION OF THE DRAWINGS

Below, a detailed description will be made of the preferred embodiments of the present invention, for which, in order to help towards its better understanding, drawings are attached, merely given by way of non-limiting example, wherein:

FIGS. 1 to 4 are schematic views corresponding to different variants of the ink containers of the present invention;

FIGS. 5 and 6 are two schematic views, that show other variants of the ink container outlet opening means;

FIGS. 7 to 11 are elevational schematic views that show different embodiments of the pressure and flattening means of the device of the present invention; and

FIG. 12 illustrates an application of the present invention to a printing body system.

### DETAILED DESCRIPTION OF THE DRAWINGS

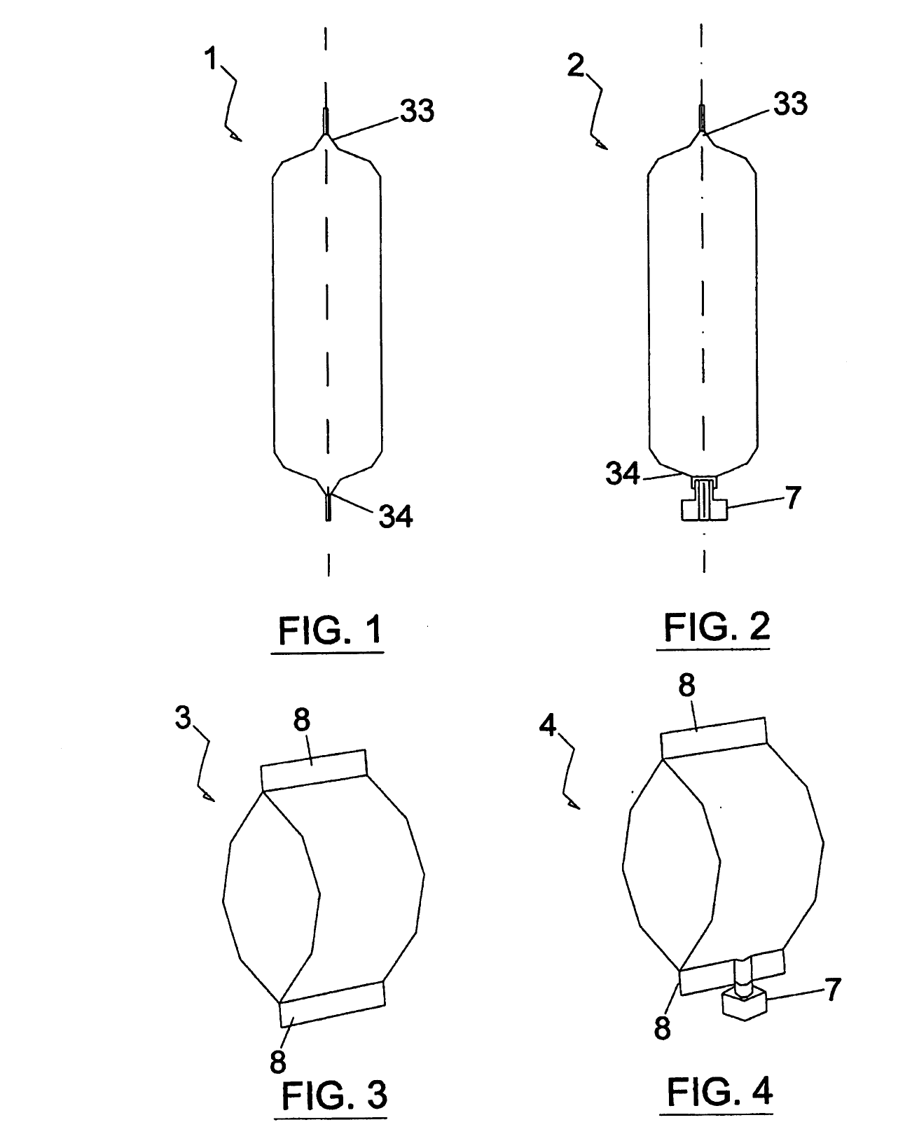

In FIGS. 1 to 4 of said drawings it can be seen that a container 1, 2, 3, 4, 10 according to the invention may adopt different forms. The containers 1, 2, 3, 4, 10 of the invention are particularly, although not exclusively, applicable to the storage of inks to be used in the graphic industry, for their subsequent dispensing according to the process and in the device of the invention.

This dispensing process, of a known form, comprises supplying the ink in a container 1, 2, 3, 4, 10 and providing the container 1, 2, 3, 4, 10 in a dispensing system, which comprises a tank 6 wherein doses of ink are poured.

For the embodiment of the process of the invention, the container 1, 2, 3, 4, 10 has deformable walls and an outlet.

In this way, according to the invention, the process further comprises the steps of: supplying the ink in the container 1, 2, 3, 4; supporting the partially full or full container 1, 2, 3, 4, in the dispensing system 5; opening the outlet of the container 1, 2, 3, 4; exerting pressure, by pressure and flattening means, against the container walls 1, 2, 3, 4, against the opening.

In this way, the combined action of compression pushes the ink contained in the container 1, 2, 3, 4, thanks to the possibility of deformation by flattening the walls thereof, against the opening, whereby doses of ink, conveniently measured and restricted, exit.

In this way it manages to combine an ink dispensing system, with the provision thereof in containers which may be of elastic, plastic or paper containers, enabling the costly manipulation of tins of dye or paint to be eliminated.

Examples of containers according to the invention are: an essentially cylindrical bag 1, e.g. plastic, aluminium or paper material, with the longitudinal ends 33, 34 closed by any means, e.g. heat welding (FIG. 1); a bag 2 like the previous one, but provided with a screw cap 7 at one of its ends (FIG. 2); a bag 3 of squared front format and side format which is essentially oval (FIG. 3), with flat protruding projections 8 on the edges; and a bag 2 like that of FIG. 3, but provided with a screw cap 7 at one of its ends (FIG. 4).

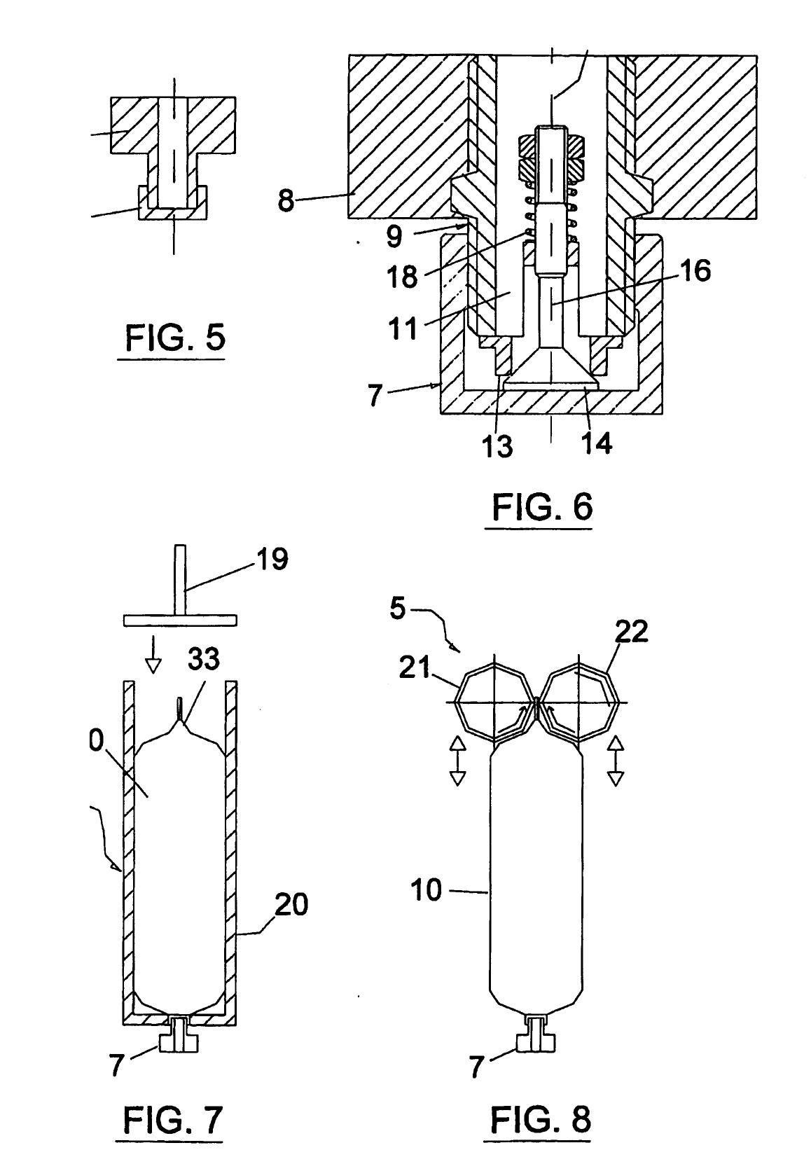

The container 1, 2, 3, 4, 10 of the invention may comprise outlet-opening means, like an aforementioned screw cap 7. FIG. 5 illustrates an example wherein the container outlet has a screw cap 7, which may be of conventional type.

The opening means may comprise a “push-pull” type device (not shown in the drawings), wherein when an element surrounding the outlet is pulled, it opens, closing when said element is pressed.

The outlet of the container 1, 2, 3, 3 perfectly couples to the fixed part of the dispensing system 5 by outlet coupling means.

FIG. 6 shows an example of embodiment of the opening means, provided with a lower valve 9, whose valve body comprises an inner space 11 which connects to the inside of the container, the sealing element 13 of the valve being a cap 14, displaceable between a position of maximum opening and a closed position, wherein the larger base 15 of the seal is essentially level with the valve outlet, closing the container.

The sealing element 13 is joined to an actuating rod 16 which runs through the inside of said inner cylindrical space of the valve body and which is actuated by a tappet 17, against the action of a spring 18.

For the ink dispensing of the invention, for the implementation of the process to use in conjunction with a container 1, 2, 3, 4, 10 of those described comprises support means for the ink container 1, 2, 3, 4, 10, ink dispensing means and a tank 6 wherein doses of ink from the container 1, 2, 3, 4 are poured. The device further comprises container outlet-opening means, and means for exerting pressure against the deformable walls of the container, against said container outlet, so that, as has been mentioned, the combined action of compression pushes the ink contained in the container 1, 2, 3, 4, thanks to the possibility deforming the deformable walls of the container 1, 2, 3, 4, by the flattening thereof, against the opening, whereby the doses of ink exit to said tank 6.

The device preferably comprises operating time control means for the pressure and flattening means on the container 1, 2, 3, 4. With the operating time control means of the pressure means, the step of exerting pressure is performed for a predetermined time, said ink doses being in accordance with said predetermined time. The process may also optionally comprise a dispensing time control step, wherein said predetermined time is controlled by the control means.

A possibility contemplated for the control means is that they are means to measure the weight of the dose of ink that exits the container outlet 1, 2, 3, 4, so that it controls the quantity of ink dispensed. In this way, said time control step comprises the measuring of the weight dose that exits the outlet.

Another possibility consists of providing height-measuring means, in the tank 6, of the dispensed fluid of the dose that exits the outlet, in order to be able to, for example, keep the height of ink constant in the tank 6.

In the examples of embodiment illustrated, the opening means are arranged in lower position, and the pressure and flattening means are adapted for exerting pressure downwards against the deformable walls of the container 1, 2, 3, 4.

FIG. 7 represents a first example of embodiment wherein the pressure and flattening means comprise a plunger 19 that acts on deforming the container against the opening of the container 10, which is retained between the walls 20 of the dispensing system 5.

FIG. 8 represents a second example of embodiment, wherein the pressure and flattening means comprise at least two antagonistic cylinders 21, 22, which are displaced vertically and in parallel to one another against the deformable walls of the container 10 and against the opening. This flattening occurs with the parallel lowering of the cylinders 21, 22.

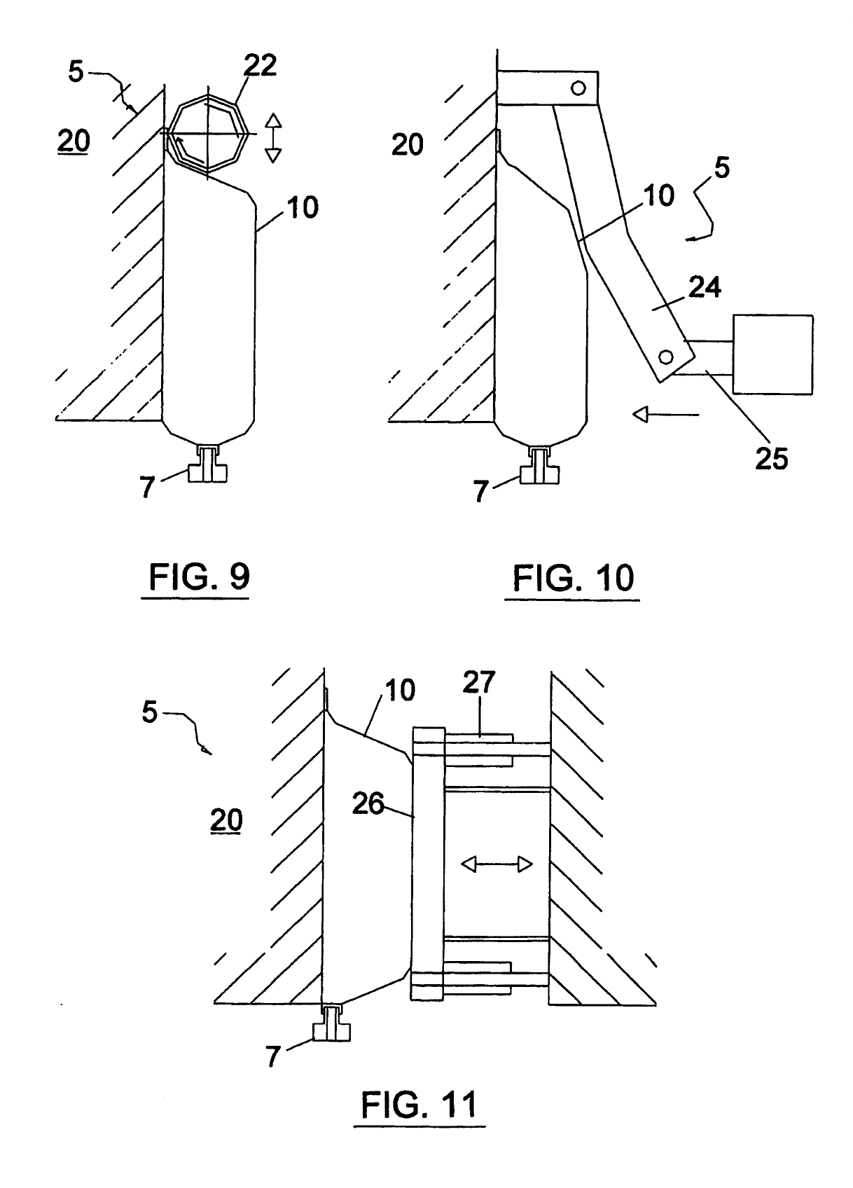

FIG. 9 represents a third example of embodiment, wherein the pressure and flattening means comprise at least one cylinder 23 which are simultaneously vertically displaced downwards against the deformable walls of the container 10, against a fixed, non-deformable wall 20 of the dispensing system 5 and against the opening.

FIG. 10 represents a fourth example of embodiment, wherein the pressure and flattening means comprise a handle 24 of a connecting rod 25-handle 24 mechanism, actuated by a plunger, adapted for simultaneously exerting pressure against the deformable walls of the container 10, against a fixed non-deformable wall 20 of the dispensing system 5 and against the opening. The handle 24 has a certain curve to facilitate the deformation of the container 10.

FIG. 11 represents a fifth example of embodiment, wherein the pressure and flattening means comprise a plate 26, actuated by at least one cylinder 27, which exerts pressure simultaneously and perpendicularly against the deformable walls of the container 10 and against a fixed, non-deformable wall 20 of the dispensing system.

FIG. 12 shows a specific example of application of the present invention, in particular, to a system of printing bodies. Typically, this system consists of a lower tank 6, wherein a level 28 of ink 29 is maintained. Several rollers 30, 31, 32 transfer the ink 29 to a final support, wherein the image of the last of the rollers will be printed, for example, by transfer. In this specific example, a specific case has been represented wherein a system of printing bodies is applied to dispensing devices wherein the pressure and flattening means comprise two antagonistic cylinders 21, 22 and the container 10 has a screw cap 7.

Although the present invention has been explained in relation to ink dispensing, it is also applicable to the dispensing of paints, basic dyes to produce paints, as well as to other products of similar rheology.

The container, the process and the device claimed below, constitute a single general inventive concept, since each of the three aspects claimed has been conceived and devised for its use in the remaining two concepts.

1. Process for ink dispensing, of the type that comprise supplying ink in a container, and the container having a dispensing system, that comprises a tank where doses of ink are poured, characterized in that it comprises the steps of:
supplying the ink in a container with deformable walls, provided with container opening means;
supporting the full or partially full container in the dispensing system;
opening the container using the opening means, determining an opening; and
exerting pressure, using pressure and flattening means, against the container walls, against said opening,
so that the combined action of compression pushes the ink contained in the container, thanks to the possibility of deforming the container walls, by the flattening thereof, against the opening, whereby a dose of ink exits.

2. Process according to claim 1, characterized in that the step of exerting pressure is performed for a predetermined time, said ink dose being in accordance with said predetermined time.

3. Process according to claim 2, characterized in that it comprises a dispensing time control step, wherein said predetermined time is controlled by control means.

4. Process according to claim 3, characterized in that said time control step comprises the measuring of the weight that exits the outlet.

5. Process according to claim 3, characterized in that said time control step comprises measuring the height, in the tank, of the dispensed fluid of the dose which exits the outlet.

6. Process according to claim 1, characterized in that said outlet is fixed, in the dispensing system, in a lower position, and said pressure is exerted downwards against the deformable walls of the container.

7. Process according to claim 1, characterized in that the step of exerting pressure comprises exerting pressure using a manual plunger and/or lever.

8. Process according to claim 1, characterized in that the step of exerting pressure comprises exerting pressure by the action of at least two antagonistic cylinders which are displaced vertically downwards against the container walls.

9. Process according to claim 1, characterized in that the step of exerting pressure comprises exerting pressure using at least one cylinder which is simultaneously vertically displaced downwards against the deformable walls of the container and against a fixed, non-deformable wall of the dispensing system.

10. Process according to claim 1, characterized in that the step of exerting pressure comprises simultaneously exerting pressure against the deformable walls of the container and against a fixed, non-deformable wall of the dispensing system, using a handle of a connecting rod-handle mechanism actuated by a plunger.

11. Container for ink dispensing, to be used in a process according to claim 1, characterized in that its walls are deformable.

12. Container according to claim 11, characterized in that it comprises an outlet for the ink contained to be dispensed.

13. Container according to claim 12, characterized in that it comprises outlet-opening means.

14. Container according to claim 13, characterized in that said opening means comprise a cap.

15. Container according to claim 13, characterized in that said opening means comprise a “push-pull” type device, wherein when the element which surrounds the outlet is pulled, it opens, closing when said element is pressed.

16. Container according to claim 11, characterized in that it comprises coupling means of the outlet to the fixed part of the dispensing system.

17. Container according to claim 11, characterized in that said opening means comprise a lower valve, whose valve body comprises an inner space which connects to the inside of the container, the valve sealing element being a cap, displaceable between a position of maximum opening and a closed position, wherein the larger base of the seal is essentially level with the valve outlet, closing the container.

18. Container according to claim 17, characterized in that said sealing element is joined to an actuating rod which runs inside said inner cylindrical space of the valve body and is actuated in turn by a tappet, against the action of a spring.

19. Ink dispensing device, for the implementation of a process according to claim 1 and to be used in conjunction with a container having deformable walls and a container outlet, of the type of devices that comprise support means for the ink container, ink dispensing means and a tank wherein doses of ink are poured from the ink container, characterized in that it comprises container outlet opening means, and in that the ink dispensing means comprise means for exerting pressure against the deformable walls of the container, against said container outlet, so that the combined action of compression pushes the ink contained in the container, thanks to the possibility of deforming the deformable walls of the container, by the flattening thereof, against the opening, whereby doses of ink exit towards said tank.

20. Device according to claim 19, characterized in that it comprises operating time control means for the pressure and flattening means on the container.

21. Device according to claim 20, characterized in that said control means comprise means for measuring the weight of the ink dose which exits the container outlet.

22. Device according to claim 20, characterized in that said control means comprise height-measuring means, in the tank, of the fluid dispensed of the dose that exits the outlet.

23. Device according to claim 19, characterized in that the opening means are arranged in lower position, and the pressure and flattening means are adapted for exerting pressure downwards against the deformable walls of the container.

24. Device according to claim 19, characterized in that said pressure and flattening means comprise a plunger which acts on deforming the container against the opening.

25. Device according to claim 19, characterized in that said pressure and flattening means comprise at least two antagonistic cylinders that are displaced vertically and in parallel to one another against the deformable walls of the container and against the opening.

26. Device according to claim 19, characterized in that said pressure and flattening means comprise at least a cylinder which is simultaneously displaced downwards against the deformable walls of the container, against a fixed, non-deformable wall of the dispensing system and against the opening.

27. Device according to claim 19, characterized in that said pressure and flattening means comprise a handle of a connecting rod-handle mechanism actuated by a plunger, adapted for simultaneously exerting pressure against the deformable walls of the container, against a fixed, non-deformable wall of the dispensing system and against the opening.

28. Device according to claim 19, characterized in that said pressure and flattening means comprise a plate, actuated by at least a cylinder, which exerts pressure simultaneously and perpendicularly against the deformable walls of the container and against a fixed, non-deformable wall of the dispensing system.
